(19) United States
(12) Patent Application Publication
(10) Pub. No.: US 2016/0253051 A1
(43) Pub. Date: Sep. 1, 2016

(54) DISPLAY APPARATUS AND METHOD FOR CONTROLLING THE SAME

(71) Applicant: SAMSUNG ELECTRONICS CO., LTD., Suwon-si (KR)

(72) Inventors: Jeong-youb KIM, Seoul (KR); Ronan BOUROULLEC, Paris (FR); Erwan BOUROULLEC, Paris (FR)

(73) Assignee: SAMSUNG ELECTRONICS CO., LTD., Suwon-si (KR)

(21) Appl. No.: 15/054,316

(22) Filed: Feb. 26, 2016

(30) Foreign Application Priority Data
Feb. 26, 2015 (KR) 10-2015-0027060

(51) Int. Cl. G06F 3/0482; G06F 3/0481; G06F 7/08; G06F 3/0484

(52) U.S. Cl. CPC G06F 3/0482; G06F 3/04842; G06F 3/04845; G06F 3/04847; G06F 3/04817; G06F 7/08

(57) ABSTRACT

A display apparatus and a method for controlling the same are provided. The method includes displaying a content guide User Interface (UI) including a plurality of content bars classified by category, extending, in response to a content bar being selected from among the plurality of content bars, the selected content bar, and displaying at least one content included in a category corresponding to the selected content bar in a content area generated by the extended content bar. Accordingly, the display apparatus provides a user with content information intuitionally, thereby enabling the user to access to a desired content more easily.

### CROSS-REFERENCE TO RELATED APPLICATIONS

This application claims the benefit of priority under 35 U.S.C. §119 from Korean Patent Application No. 10-2015-0027060, filed on Feb. 26, 2015, in the Korean Intellectual Property Office, the disclosure of which is incorporated herein by reference in its entirety.

### BACKGROUND

1. Field

The present general concept relates to a display apparatus and a method for controlling the same, and more particularly, to a display apparatus for intuitionally providing a content and a method for controlling the same.

2. Description of the Related Art

With the development of diverse electronic apparatuses, such as, a smart phone, a smart television (TV), a tablet Personal Computer (PC), etc., a user is able to use a desired content faster and more easily.

However, as an amount of contents provided through a content service increases rapidly, various contents are arranged according to a rule defined by a content provider. Accordingly, the user should suffer inconvenience of tracking a route to the desired content in order to use the content. Furthermore, when the user wishes to use the content again after using the content once but does not remember the route to the content, the user should spend time similar to or longer than the time spent on retrieving the content first.

In addition, the existing route User Interface (UI) screen for retrieving a content remains at a level where users may feel visual fatigue, and thus, it is difficult for the user in various age groups to use the content service.

### SUMMARY

Additional aspects and/or advantages will be set forth in part in the description which follows and, in part, will be apparent from the description, or may be learned by practice of the embodiments.

The present disclosure has been provided to address the aforementioned and other problems and disadvantages occurring in the related art, and an aspect of the present disclosure provides a display apparatus for intuitionally providing a user with content information and a method for controlling the same.

In addition, an aspect of the present disclosure provides a display apparatus for intuitionally providing the user with the content information thereby enabling the user to use various contents more effectively and a method for controlling the same.

According to an exemplary embodiment, there is provided a method for controlling a display apparatus, the method including: displaying a content guide User Interface (UI) including a plurality of content bars classified by category, extending, in response to a content bar being selected from among the plurality of content bars, the selected content bar, and displaying at least one content included in a category corresponding to the selected content bar in a content area generated by the extended content bar.

The content guide UI may include a first content bar and a second content bar which are apart from each other at a predetermined distance in a vertical or horizontal pattern and a space area including a plurality of stripe-patterned lines between the first content bar and the second content bar.

The displaying the content guide UI may include displaying identification information for identifying a category corresponding to each of the first content bar and the second content bar on the first content bar and the second content.

The displaying the content guide UI may include setting and displaying at least one of a thickness, a color, an arrangement order, and a bookmark of the first content bar and the second content bar according to a predetermined condition. The predetermined condition may include at least one of user setting information, selection history information, and content attribute information.

The displaying the content guide UI may include displaying a thickness of at least one stripe-patterned line adjacent to a content bar having higher selection frequency out of the first content bar and the second content bar differently from a thickness of other striped-patterned lines based on the selection history information.

In response to the first content bar being selected, the extending the selected content bar may include extending the selected first content bar to a first critical size based on extension information on the category corresponding to the first content bar, and in response to the second content bar being selected, extending the selected second content bar to a second critical size based on extension information on the category corresponding to the second content bar. The first content bar and the second content bar may be extended in a certain direction, in a horizontal direction, or in a vertical direction.

In response to the first content bar being extended to the first critical size, the extending the selected content bar may include moving the second content bar and the space area between the first content bar and the second content bar by an amount of the first critical size.

In response to the first content bar being extended to the first critical size, the extending the selected content bar may include adjusting the space area adjacent to the first content bar by the amount of the first critical size.

The displaying the at least one content may include displaying a plurality of thumbnail contents in the content area generated by the extended content bar and displaying, in response to a thumbnail content being selected from among the plurality of thumbnail contents, a detailed content on the selected thumbnail content.

The displaying the detailed content may include adjusting extension of a content area for displaying the detailed content and displaying the detailed content in the adjusted content area according to an attribute of the selected thumbnail content.

According to an exemplary embodiment, there is provided a display apparatus including: a display configured to display a content guide User Interface (UI) including a plurality of content bars classified by category and a controller configured to, in response to a content bar being selected from among the plurality of content bars, extend the selected content bar and control the display to display at least one content included in a category corresponding to the selected content bar in a content area generated by the extended content bar.

The content guide UI may include a first content bar and a second content bar which are apart from each other at a predetermined distance in a vertical or horizontal pattern and a space area including a plurality of stripe-patterned lines between the first content bar and the second content bar.

The controller may control the display to display identification information for identifying a category corresponding to each of the first content bar and the second content bar on the first content bar and the second content.

The controller may set at least one of a thickness, a color, an arrangement order, and a bookmark of the first content bar and the second content bar according to a predetermined condition. The predetermined condition may include at least one of user setting information, selection history information, and content attribute information.

The controller may set a thickness of at least one stripe-patterned line adjacent to a content bar having higher selection frequency out of the first content bar and the second content bar differently from a thickness of other striped-patterned lines based on the selection history information.

In response to the first content bar being selected, the controller may extend the selected first content bar to a first critical size based on extension information on the category corresponding to the first content bar, and in response to the second content bar being selected, extend selected second content bar to a second critical size based on extension information on the category corresponding to the second content bar. The first content bar and the second content bar may be extended in a certain direction, in a horizontal direction, or in a vertical direction.

In response to the first content bar being extended to the first critical size, the controller may move the second content bar and the space area between the first content bar and the second content bar by an amount of the first critical size.

In response to the first content bar being extended to the first critical size, the controller may adjust the space area adjacent to the first content bar by the amount of the first critical size.

The controller may control the display to display a plurality of thumbnail contents in the content area generated by the extended content bar and in response to a thumbnail content being selected from among the plurality of thumbnail contents, display a detailed content on the selected thumbnail content.

The controller may control the display to adjust extension of a content area for displaying the detailed content and display the detailed content in the adjusted content area according to an attribute of the selected thumbnail content.

According to an exemplary embodiment, there is provided a non-transitory computer readable medium storing a method for controlling a display apparatus, the method for controlling a display apparatus including displaying a content guide User Interface (UI) including a plurality of content bars classified by category, extending, in response to a content bar being selected from among the plurality of content bars, a selected content bar as an extended content bar and displaying at least one content included in a category corresponding to the selected content bar in a content area generated by the extended content bar.

According to an exemplary embodiment, there is provided a display apparatus including a display configured to display a graphical user interface content guide and a controller configured to produce the guide, the guide including expandable content bars aligned in a first direction comprising one of a horizontal and vertical direction, each of the content bars corresponding to a different category of displayable information, each of the content bars being expandable by a user interaction in a second direction opposite the one of the horizontal and vertical direction, each of the content bars including content thumbnail icons, each of the icons representing detailed content within a corresponding category and the detailed content corresponding a selected one of the icons being displayed when the user interaction selects the selected one of the icons.

The apparatus may display an expanded content bar and the icons in the expanded content bar at a same time allowing a user to visually track a route to a desired detailed content.

According to the above-described various exemplary embodiments, the display apparatus provides a user with content information intuitionally, thereby enabling the user to access to a desired content more easily. In addition, according to the exemplary embodiments, the display apparatus provides warning information on a content more concisely, thereby minimizing visual fatigue.

### BRIEF DESCRIPTION OF THE DRAWINGS

The above and/or other aspects of the present concept will be more apparent by describing certain exemplary embodiments of the present concept with reference to the accompanying drawings, in which:

FIG. 1 is a block diagram illustrating a display apparatus according to an exemplary embodiment;

FIG. 2 is a detailed block diagram illustrating a display apparatus according to an exemplary embodiment;

FIG. 3 is a demonstration diagram provided to describe an exemplary embodiment of displaying a content guide UI in a display apparatus according to an exemplary embodiment;

FIG. 4 is a demonstration diagram provided to describe an exemplary embodiment regarding a plurality of content bars included in a content guide UI in a display apparatus according to an exemplary embodiment;

FIG. 5 is a demonstration diagram provided to describe an exemplary embodiment of displaying a content guide UI in response to a user command in a display apparatus according to an exemplary embodiment;

FIG. 6 is a demonstration diagram provided to describe an exemplary embodiment of displaying content in a content area according to extension of a content bar of a content guide UI in a display apparatus according to an exemplary embodiment;

FIG. 7 is a first demonstration diagram provided to describe an exemplary embodiment of extending a content bar included in a content guide UI in a display apparatus according to an exemplary embodiment;

FIG. 8 is a second demonstration diagram provided to describe an exemplary embodiment of extending a content bar included in a content guide UI in a display apparatus according to another exemplary embodiment;

FIG. 9 is a demonstration diagram provided to describe an exemplary embodiment of extending and displaying content in a content area included in a content execution UI in a display apparatus according to an exemplary embodiment;

FIG. 10 is a first demonstration diagram provided to describe an exemplary embodiment of editing a content bar included in a content guide UI in a display apparatus according to an exemplary embodiment;

FIG. 11 is a second demonstration diagram provided to describe an exemplary embodiment of editing a content bar included in a content guide UI in a display apparatus according to another exemplary embodiment;

FIG. 12 is a third demonstration diagram provided to describe an exemplary embodiment of editing a content bar included in a content guide UI in a display apparatus according to still another exemplary embodiment;

FIG. 13 is a flowchart provided to describe a method for displaying a content in a display apparatus according to an exemplary embodiment; and

FIG. 14 is a flowchart provided to describe a method for extending a content bar in a display apparatus according to an exemplary embodiment.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

The terms “first”, “second”, etc. may be used to describe diverse components, but the components are not limited by the terms. The terms are only used to distinguish one component from the others.

The terms used in the present application are only used to describe the exemplary embodiments, but are not intended to limit the scope of the disclosure. The singular expression also includes the plural meaning as long as it does not differently mean in the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

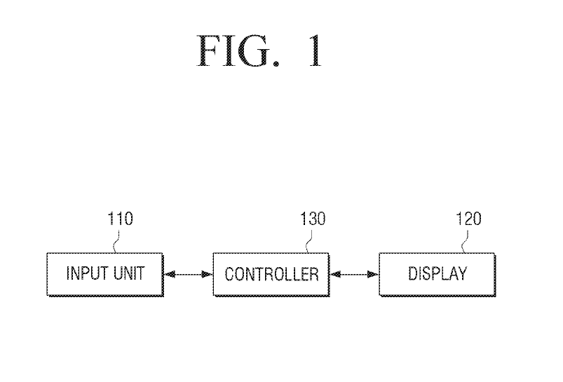

FIG. 1 is a block diagram illustrating a display apparatus according to an exemplary embodiment.

As illustrated in FIG. 1, a display apparatus includes an input unit 110, a display 120, and a controller 130 which may be a computer or a processor with a memory.

The input unit 110 receives a user command through an input means, such as, a manipulator (not shown) or a touch panel (not shown) of the display apparatus, and transmits the received user command to the controller 130, but not limited thereto. That is, the input unit 110 may sense a user motion and transmit a user command corresponding to the sensed user motion to the controller 130. In this case, the user command may be a command to control a content guide UI displayed in the display apparatus or a function setting command of the display apparatus.

The display 120 displays image-processed content or On-Screen Display (OSD) information in a screen. Specially, the display 120 displays a content guide UI (or graphical user interface—GUI) including a plurality of content bars classified by category. In response to a user command being received through the input unit 110, such as, the manipulator (not shown) or the touch panel (not shown), or a user command corresponding to a sensed user motion being received while the content guide UI is displayed, the display 120 may display a content corresponding to the received user command.

The controller 130 controls overall operations of components of the display apparatus. Specially, in response to a content bar being selected from among of the plurality of content bars through the input unit 110 while the content guide UI (user interface) is displayed by the display 120, the controller 130 extends (or expands the width or height of, as appropriate) the selected content bar and controls the display 120 to display at least one content included in a category corresponding to the selected content bar in a content area generated by the extended content bar. According to the control command, the display 120 may display at least one content included in the category corresponding to the selected content bar in a content area generated in connection with the content bar selected by a user.

In this case, the content guide UI may include a first content bar and a second content bar which are apart from each other at a predetermined distance in a vertical or horizontal pattern and a space area including a plurality of stripe-patterned lines between the first content bar and the second content bar.

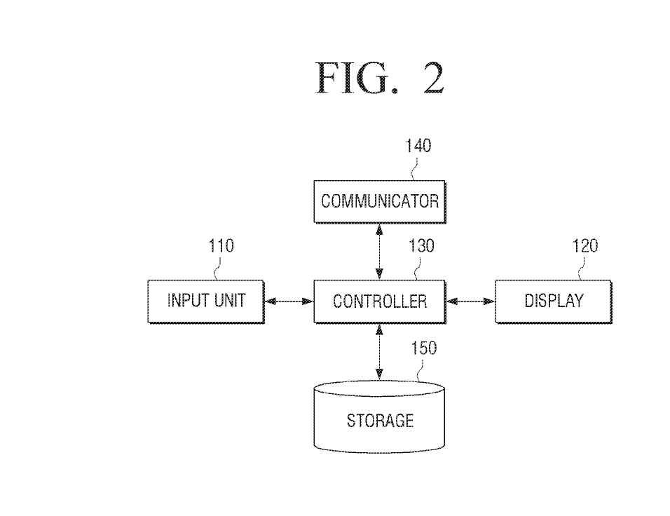

FIG. 2 is a detailed block diagram illustrating a display apparatus according to an exemplary embodiment.

As illustrated in FIG. 2, the display apparatus may further include a communicator 140 and storage 150 on top of the above-described input unit 110, the display 120, and the controller 130.

The communicator 140 may communicate with a content server which provides a content (not shown) or an adjacent peripheral terminal device which is capable of communicating with the display apparatus in a wired and/or wireless manner to receive a content requested by the user or communicate with a remote controller (not shown) for controlling the display apparatus to receive a user command.

The communicator 140 may include diverse communication modules such as a local area wireless communication module (not shown), a wireless communication module (not shown), etc. In this case, the local area wireless communication module refers to a module for performing wireless communication with a peripheral terminal device (not shown) located at a close range, such as a display apparatus (not shown), a user terminal device (not shown), etc., according to a local area wireless communication method such as Bluetooth, Zigbee, etc. In addition, the wireless communication module refers to a module which is connected and communicate with an external network according to a wireless communication protocol such as Wireless-Fidelity (Wi-Fi), Institute of Electrical and Electronics Engineers (IEEE), etc. The wireless communication module may further include a mobile communication module which accesses a mobile communication network and performs communication according to various mobile communication standards such as 3rd Generation (3G), 3rd Generation Partnership Project (3GPP), Long Term Evolution (LTE), etc.

The storage 150 may store an operating system program for controlling the operations of the display apparatus and an application program which is managed by the operating system, performs the operations of the display apparatus by using resources of the operating system, and provides a user interface. In this case, in response to the display apparatus being turned on, the operating system may be a program which is read out of the storage 150 and compiled to drive respective components of the display apparatus. In addition, the storage 150 may store various multimedia data processed by the controller 130, image contents, data received from an external source, etc. The storage 150 may be realized as at least one of Read-Only Memory (ROM), Random Access Memory (RAM), memory card which is detachable with respect to a broadcasting receiver 100 (for example, Secure Digital (SD) card or memory stick), non-volatile memory, volatile memory, Hard Disk Drive (HDD), and Solid State Drive (SDD).

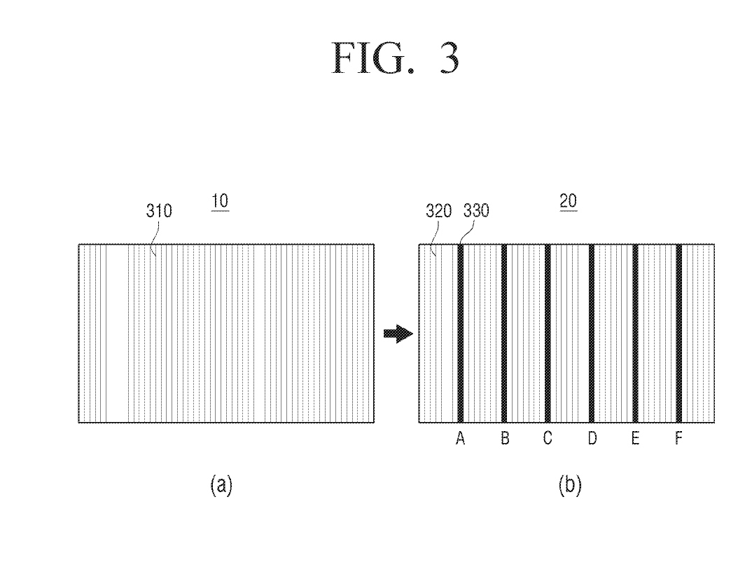

FIG. 3 is a demonstration diagram provided to describe an exemplary embodiment of displaying a content guide UI in a display apparatus according to an exemplary embodiment.

The controller 130 executes an application for intuitionally providing content according to a user command. As illustrated in FIG. 3(a), the display 120 displays a start UI 10 of the application for intuitionally providing content in response to the above execute command. In this case, the start UI 10 of the application for intuitionally providing content may include a plurality of stripe-patterned lines 310.

In response to a predetermined event occurring while the start UI 10 is displayed, the controller 130 controls the display 120 to generate a content guide UI and display the generated content guide UI. In this case, the predetermined event may be an event where a user motion is sensed or an event where a user touch command is received. In response to the event occurring, the display 120 displays a content guide UI 20 as illustrated in FIG. 3(b).

In this case, the content guide UI 20 may include a plurality of content bars 330 which are apart from other at a predetermined distance in a vertical pattern and classified by category and a space area 320 including a plurality of stripe-patterned lines in the plurality of content bars 330. As illustrated, the plurality of content bars 330 may include a first content bar corresponding to Category A, a second content bar corresponding to Category B, a third content bar corresponding to Category C, a fourth content bar corresponding to Category D, and a fifth content bar corresponding to Category E.

The controller 130 may control the display 120 to display identification information for identifying a category corresponding to each of the first content bar and the second content bar on the first content bar and the second content bar included in the content guide UI. In addition, the controller 130 may set at least one of a thickness, a color, an arrangement order, and a bookmark of the first content bar and the second content bar according to a predetermined condition. In this case, the predetermined condition may include at least one of user setting information, selection history information, and content attribute information.

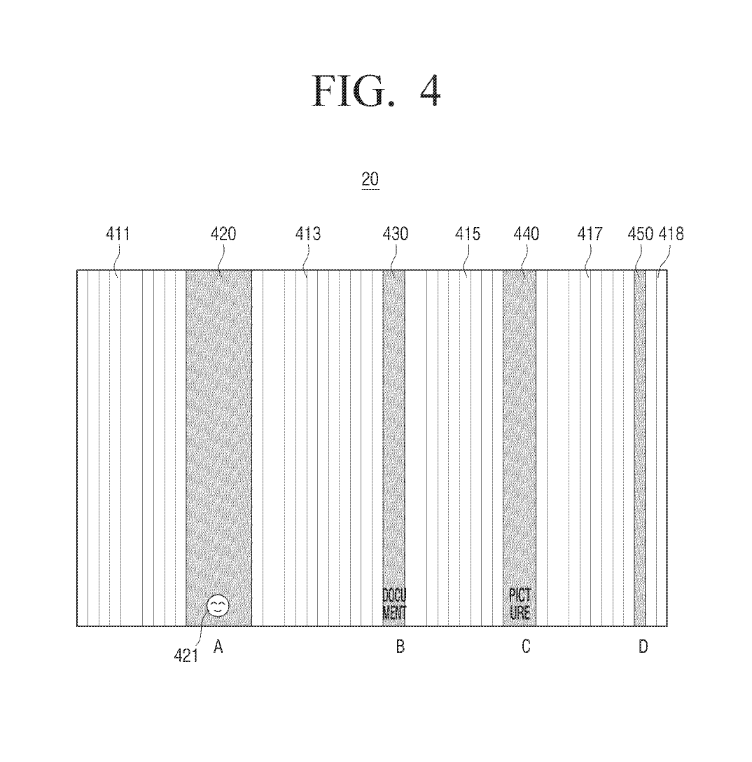

FIG. 4 is a demonstration diagram provided to describe an exemplary embodiment regarding a plurality of content bars included in a content guide UI (or GUI) in a display apparatus according to an exemplary embodiment.

As illustrated in FIG. 4, the content guide UI 20 may include a first content bar 420 corresponding to Category A, a second content bar 430 corresponding to Category B, a third content bar 440 corresponding to Category C, a fourth content bar 450 corresponding to Category D, and a first to fifth space areas 411 to 418 which are respectively formed between the first to fourth content bars 420 to 440. In addition, the content guide UI 20 may include identification information 421 for identifying a category corresponding to each of the first to third content bars 420 on the first to third content bars 420 to 440 among the first to fourth content bars 420 to 440 in response to a user command.

In response to the content guide UI 20 being displayed, the user is able to identify the category corresponding to each of the first to third content bars 420 to 440 based on the identification information on the first to third content bars 420 to 440 included in the content guide UI 20.

Meanwhile, the controller 130 may differently set a thickness of each of the first to fourth content bars 420 to 450 based on the category corresponding to each of the first to fourth content bars 420 to 450.

According to an exemplary embodiment, the controller 130 may differently set the thickness of each of the first to fourth content bars 420 to 450 based on a data size of a content of the category corresponding to each of the first to fourth content bars 420 to 450.

For example, the first content bar 420 may be classified into Category A related to a moving image, the second content bar 430 may be classified into Category B related to a document, and the third content bar 440 may be classified into Category C related to a picture. In this case, the content of the first content bar 420 classified into the moving image-related category has the biggest data size, and the data size of the content of the second content bar 430 may be relatively small as compared with the data sizes of the first and third contents bars 420, 440. Accordingly, the controller 130 may set the thickness of the first content bar 420 having the biggest content data size to be thicker than the thickness of other content bars and set the thickness of the second content bar 430 having the relatively small content data size as compared with the first and third contents bars 420, 440 to be thinner than the thickness of the first and third content bars 420, 440.

According to another exemplary embodiment, the controller 130 may set the thickness of each of the first to fourth content bars 420 to 450 differently based on a user setting command. For example, the user may use a content related to a moving image frequently. In this case, the user is able to set the thickness of the first content bar 420 classified into Category A related to the moving image to be thicker than the thickness of the other content bars. In response to the user setting command, the controller 130 may set the thickness of the first content bar 420 among the first to fourth content bars 420 to 450 to correspond to a thickness according to the user setting command and set the thickness of each of the other content bars to a predetermined thickness.

Accordingly, the display 120 may display in a screen a content guide UI where a thickness of at least one of the first to fourth content bars 420 to 450 is set differently.

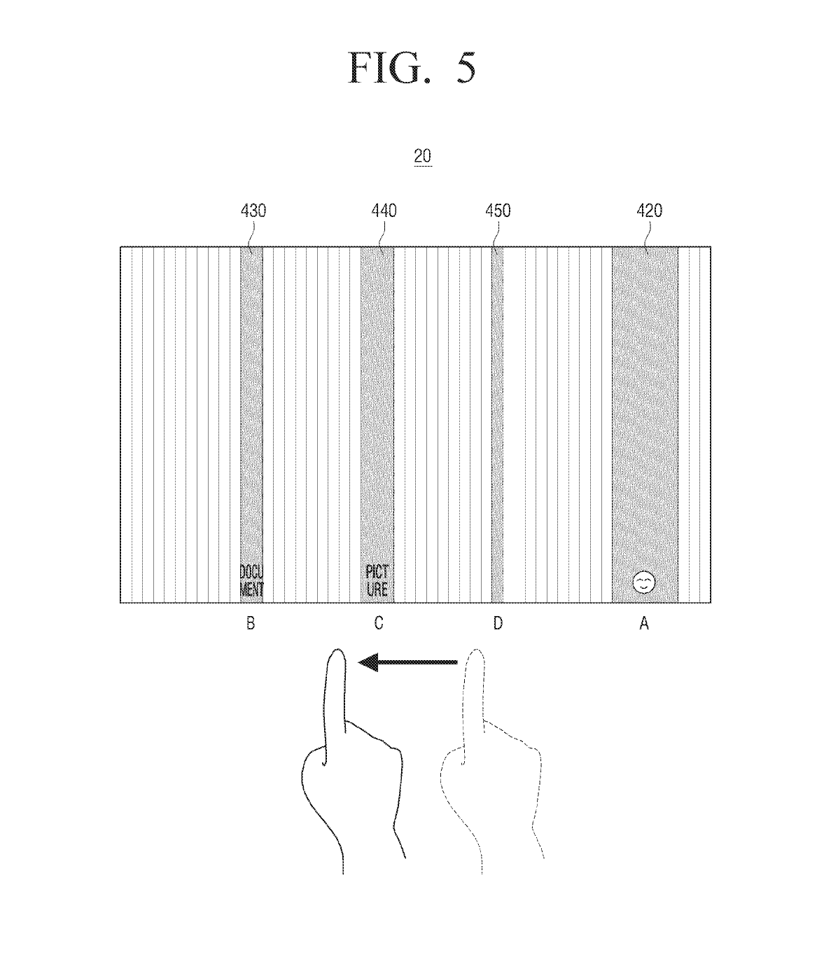

FIG. 5 is a demonstration diagram provided to describe an exemplary embodiment of displaying a content guide UI in response to a user command in a display apparatus according to an exemplary embodiment.

As described above in connection with FIG. 4, the display 120 may display the content guide UI 20. As described above, the content guide UI 20 may include the first content bar 420 corresponding to Category A, the second content bar 430 corresponding to Category B, the third content bar 440 corresponding to Category C, the fourth content bar 450 corresponding to Category D, and the first to fifth space areas 411 to 418 which are respectively formed between the first to fourth content bars 420 to 440. In addition, the content guide UI 20 may include the identification information 421 for identifying the category corresponding to each of the first to third content bars 420 to 440 in response to a user command on the first to third content bars 420 to 440 among the first to fourth content bars 420 to 440.

The user is able to take a motion of moving a user hand from right to left or performing a touch input while the content guide UI 20 is displayed. In response to the user motion being sensed or the user touch command being received, the controller 130 controls the first to fourth content bars 420 to 450 to be moved and displayed from right to left by a predetermined distance. In response to the control command, the display 120 may display in the screen the content guide UI 20 where the content bars are arranged in the order of the second content bar 430, the third content bar 440, the fourth content bar 450, and the first content bar 420.

However, the exemplary embodiment is not limited thereto. That is, in response to the user motion of moving the user hand from right to left being sensed or the user touch command being received while the content guide UI 20 where the first to fourth content bars 420 to 450 are arranged sequentially is displayed, the controller 130 controls the first to fourth content bars 420 to 450 to be moved and displayed from left to right by a predetermined distance. In response to the control command, the display 120 may display in the screen the content guide UI 20 where the content bars are arranged in the order of the fourth content bar 450, the first content bar 420, the second content bar 430, and the third content bar 440.

In response to at least one content bar being selected while the content guide UI 20 including the plurality of content bars classified by category is displayed, the controller 130 may extend the selected content bar based on extension information on the category corresponding to the selected content bar. According to an exemplary embodiment, in response to a select command with respect to the first content bar being received, the controller 130 extends the first content bar to the first critical size based on the extension information on the category corresponding to the selected first content bar. Accordingly, a content area corresponding to the first content bar may be generated. In response to a select command with respect to the second content bar being received, the controller 130 extends the second content bar to the second critical size based on the extension information on the category corresponding to the selected second content bar. Accordingly, a content area corresponding to the second content bar may be generated.

Hereinafter, there is provided the detailed description on an operation of, in response to at least one content bar being selected from among the plurality of content bars included in the content guide UI 20, extending the content bar based on extension information on a category corresponding to the selected content bar.

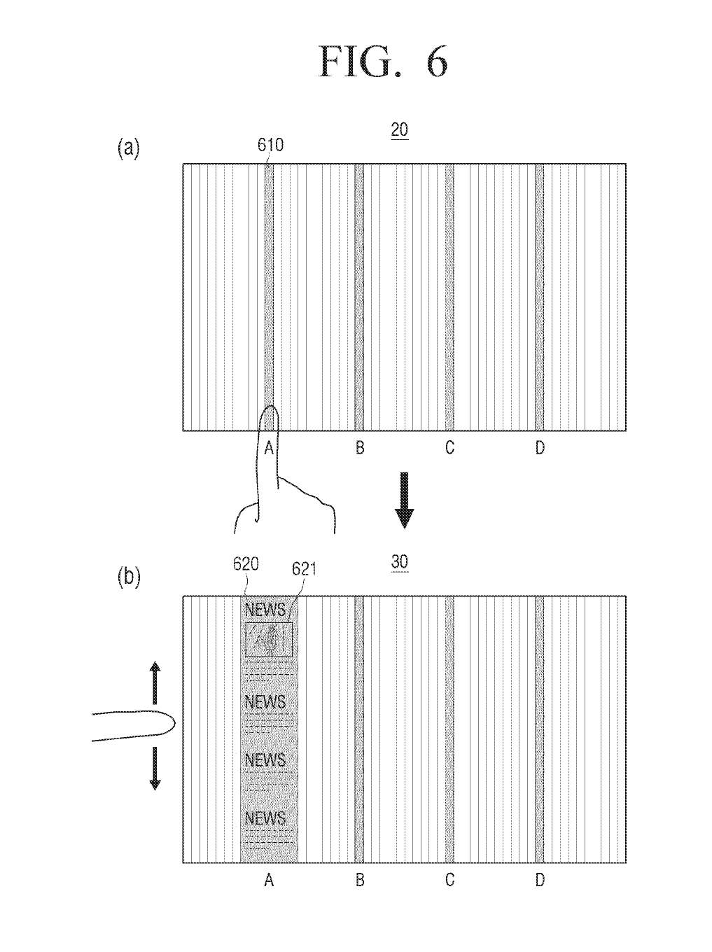

FIG. 6 is a demonstration diagram provided to describe an exemplary embodiment of displaying content in a content area according to extension of a content bar of a content guide UI in a display apparatus according to an exemplary embodiment.

As illustrated in FIG. 6(a), the display 120 may display the content guide UI 20. As described above, the content guide UI 20 may include the plurality of content bars classified by category and the space area including a plurality of stripe-patterned lines between the plurality of content bars.

The user is able to select a first content bar 610 classified into Category A from among the plurality of content bars while the content guide UI 20 is displayed. In response to a select command with respect to the first content bar 610 being received, the controller 130 may extend the first content bar 610 to a predetermined critical size based on extension information on Category A corresponding to the first content bar 610.

According to an exemplary embodiment, the extension information on each category may be set differently depending upon a content type. For example, in case of the moving image-related category, the extension information may be set so as to extend a content bar classified into the moving image-related category to the first critical size. In case of the picture-related category, the extension information may be set so as to extend a content bar classified into the picture-related category to the second critical size which is smaller than the first critical size. In case of the document-related category, the extension information may be set so as to extend a content bar classified into the document-related category to the third critical size.

Accordingly, in response to the first content bar 610 being classified into the moving image-related category, the controller 130 may extend the first content bar 610 to a predetermined first critical size based on the extension information on Category A corresponding to the first content bar 610. That is, in response to the first content bar 610 being extended to the first critical size, the controller 130 controls the display 120 to display content included in Category A corresponding to the first content bar 610 in a content area 620 with respect to the first content bar 610 extended to the first critical size. Accordingly, as illustrated in FIG. 6(b), the display 120 may display a content execute UI 30 including the content area 620 with respect to the first content bar 610 extended to the first critical size and the content bars corresponding to Categories B to D and display the content included in Category A corresponding to the first content bar 610 in the content area 620 included in the content execute UI 30.

Meanwhile, in response to a plurality of contents being included in Category A corresponding to the first content bar 610, the controller 130 controls the display 120 to generate thumbnail contents with respect to the plurality of contents and display the generated thumbnail contents in the content area 620 with respect to the first content bar 610. Accordingly, the display 120 may display the thumbnail contents with respect to the plurality of contents in the content area 620 included in the content execute UI 30. In response to a user motion for moving in a upward direction or in a downward direction being sensed or a user touch command being received while the thumbnail contents with respect to the plurality of contents (for example content 621) are displayed in the content area 620, the controller 130 may move the plurality of thumbnail contents included in the content area 620 in a direction corresponding to a upper direction or a lower direction of the user.

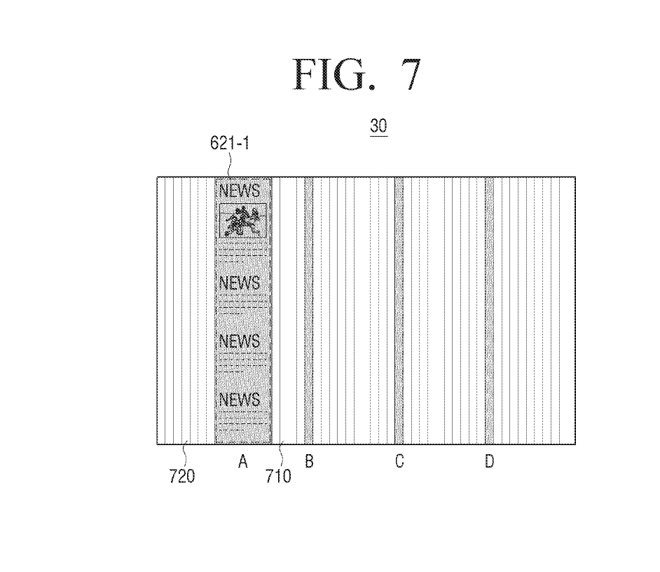

FIG. 7 is a first demonstration diagram provided to describe an exemplary embodiment of extending a content bar included in a content guide UI in a display apparatus according to an exemplary embodiment.

As described above, in response to the first content bar 610 being selected by the user from among the plurality of content bars included in the content guide UI 20, the controller 130 extends the first content bar 610 to the first critical size based on the extension information on Category A corresponding to the first content bar 610. In this case, the first critical size may be a size which is extendable within a space area 710 adjacent to the first content bar 610, but not limited thereto. That is, the first critical size may be a size which is extendable within the left space area 710 and a right space area 720 adjacent to the first content bar 610.

In response to the first content bar 610 being extended to the first critical size, the controller 130 adjusts the space area 710 adjacent to the first content bar 610 by an amount of the first critical size. Accordingly, as illustrated in FIG. 7, the display 120 may display in the screen the content execute UI 30 including a content area 621-1 generated according to the size adjustment of the selected first content bar 610 and the space area 710 of which size is reduced by the content area 621-1.

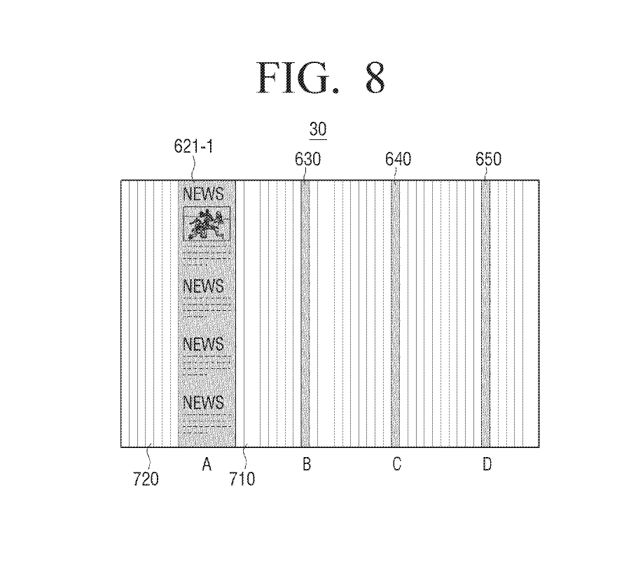

FIG. 8 is a second demonstration diagram provided to describe an exemplary embodiment of extending a content bar included in a content guide UI in a display apparatus according to another exemplary embodiment.

As described above, in response to the first content bar 610 being selected by the user from among the plurality of content bars included in the content guide UI 20, the controller 130 extends the first content bar 610 to the first critical size based on the extension information on Category A corresponding to the first content bar 610. In response to the first content bar 610 being extended to the first critical size, the controller 130 controls the display 120 to move and display the space area 710 adjacent to the first content bar 610 and a second content bar 620 by the amount of the first critical size. Accordingly, the display 120 may display in the screen the content execute UI 30 including the content area 621-1 generated according to the size adjustment of the selected first content bar 610 and the other content bars and the space area moved by the amount of the extended size of the first content bar 610.

To be specific, as illustrated in FIG. 8, in response to the first content bar 610 selected by the user being extended to the first critical size and the content area 621-1 being generated, second to fourth content bars 630 to 650 corresponding to Categories B to D and the space area 710 between the respective content bars may be moved in a certain direction by the amount of the first critical size.

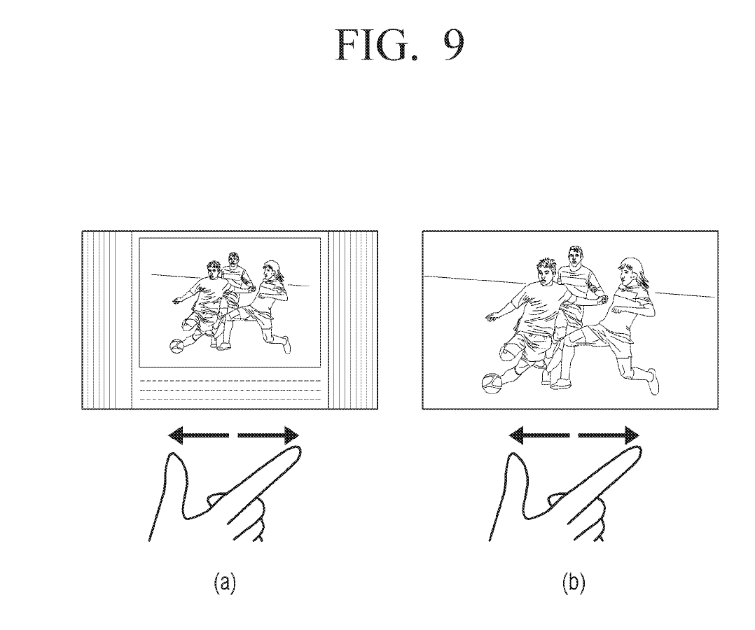

FIG. 9 is a demonstration diagram provided to describe an exemplary embodiment of extending and displaying content in a content area included in a content execution UI in a display apparatus according to an exemplary embodiment.

As described above in connection with FIG. 6, the display 120 may display the content execute UI 30 including the content area 620 with respect to the first content bar 610 extended to the first critical size and the content bars corresponding to Categories B to D and display the content included in Category A corresponding to the first content bar 610 in the content area 620 included in the content execute UI 30.

Meanwhile, in response to a plurality of contents being included in Category A corresponding to the first content bar 610, the display 120 may display the thumbnail contents with respect to the plurality of contents in the content area 620 included in the content execute UI 30. In response to a thumbnail content being selected from among the plurality of thumbnail contents while the thumbnail contents with respect to the plurality of contents are displayed in the content area 620, the controller 130 adjusts the extension of the content area 620 for displaying a detailed content according to the attribute of the selected thumbnail content. Subsequently, the controller 130 may control the display 120 to display the detailed content on the selected thumbnail content in the extended content area 620. According to the control command, the display 120 may display the detailed content corresponding to the selected thumbnail content in the content area 620.

For example, in response to a content corresponding to the selected thumbnail content being a moving image, the display 120 may extend the content area 620 to the first critical size and display the moving image in the extended content area 620 according to a control command of the controller 130. In response to a content corresponding to the selected thumbnail content being a document in a text form, the display 120 may display the document in the text form in the content area 620 according to the control command of the controller 130.

In response to a user motion related to the extension of the content area 620 being sensed or a user touch command being received while the content is displayed in the content area 620, the controller 130 may control the display 120 to extend the content area 620 based on the sensed user motion or the received user touch command. Accordingly, as illustrated in FIG. 9(a) or FIG. 9(b), the display 120 may extend the generated content area 620 and display the content in the extended content area 620.

According to an exemplary embodiment, in response to an extend command with respect to the content area 620 being received while the content is displayed in the content area 620, the display 120 may display the content by extending the content area 620 to the first critical size, as illustrated in FIG. 9(a). In response to an execute command additionally being received while the content is displayed in the content area 620 extended to the first critical size, the display 120 may display the content by extending the content area 620 to a full size, as illustrated in FIG. 9(b).

According to another exemplary embodiment, in response to a user touch command related to the extension of the content area 620 being received, the controller 130 may detect a touch time from the received touch command and determine an extension range of the content area 620 based on the detected touch time. For example, in response to the detected touch time being shorter than a predetermined critical time, the display 120 may display the content by extending the content area 620 to the first critical size, as illustrated in FIG. 9(a). In response to the detected touch time being longer than the predetermined critical time, the display 120 may display the content by extending the content area 620 to the full size, as illustrated in FIG. 9(b).

Hereinafter, there is provided the detailed description on an operation of editing a content bar included in a content guide UI in a display apparatus according to an exemplary embodiment.

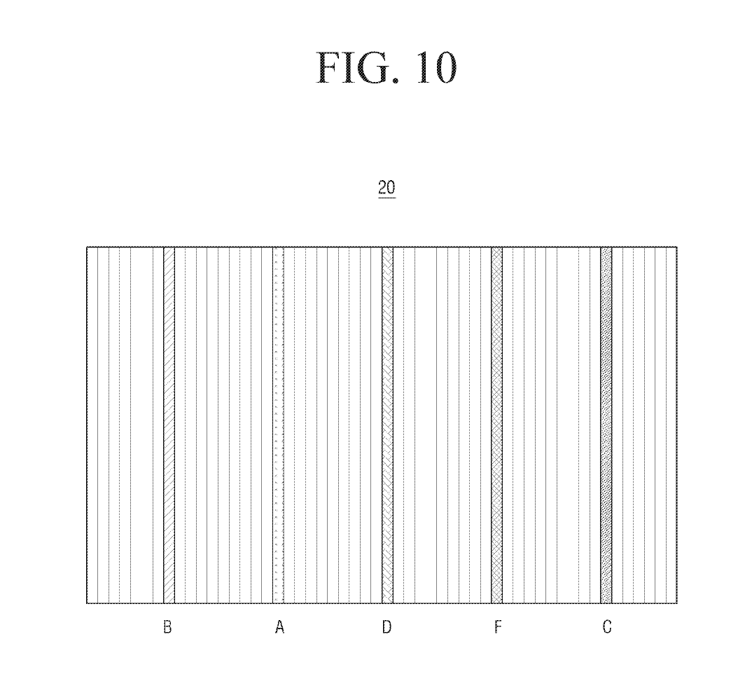

FIG. 10 is a first demonstration diagram provided to describe an exemplary embodiment of editing a content bar included in a content guide UI in a display apparatus according to an exemplary embodiment.

As illustrated in FIG. 10, the controller 130 may edit the content bars included in the content guide UI 20 according to a user setting command included in a predetermined condition. To be specific, the content bars corresponding to Categories A to D may be arranged sequentially on the content guide UI 20. In this state, the user is able to set the content bars to be rearranged in the order of a content bar classified into a category including a content that the user uses frequently. In response to an arrangement setting command being received, the controller 130 may control the display 120 to rearrange the content bars in the order corresponding to the received arrangement setting command and display the content guide UI 20 including the rearranged content bars.

According to the control command, the display 120 may display in the screen the content guide UI 20 where the content bars are rearranged in the order of a content bar corresponding to each of Categories B, A, D, F, and C.

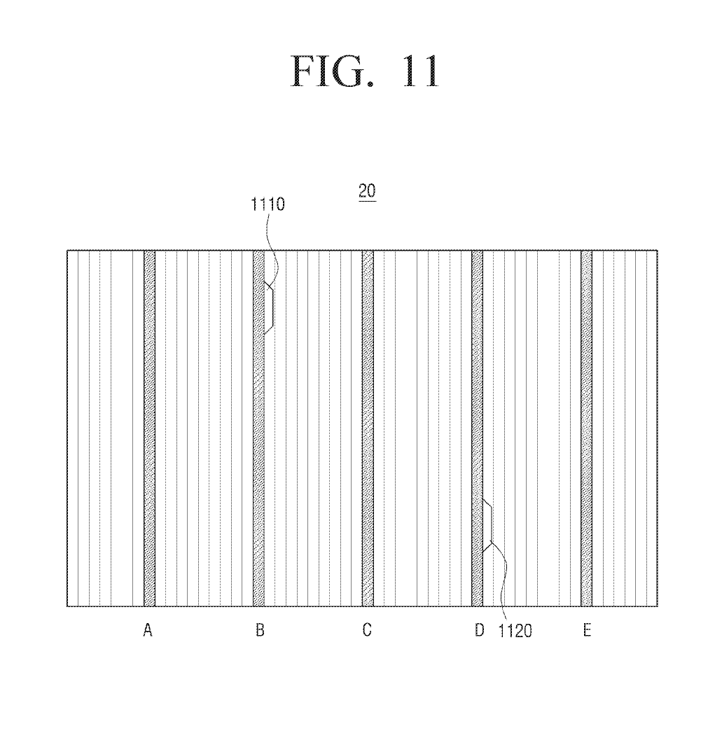

FIG. 11 is a second demonstration diagram provided to describe an exemplary embodiment of editing a content bar included in a content guide UI in a display apparatus according to another exemplary embodiment.

As illustrated in FIG. 11, the controller 130 may edit the content bars included in the content guide UI 20 according to the user setting command included in the predetermined condition. To be specific, the content bars corresponding to Categories A to D may be arranged sequentially on the content guide UI 20. In this state, the user is able to select the content bar classified into a category including a content that the user uses frequently. In response to a select command being received, the controller 130 may control the display 120 to generate a bookmark and display the generated bookmark in the content bar corresponding to the received select command.

As illustrated, in response to the select command with respect to the content bars corresponding to Categories B and D among the plurality of content bars being received, the controller 130 may control the display 120 to display the bookmarks on the content bars corresponding to the Categories B and D. Accordingly, the display 120 may display the content guide UI 20 where the bookmarks are displayed on the content bars corresponding to the Categories B and D.

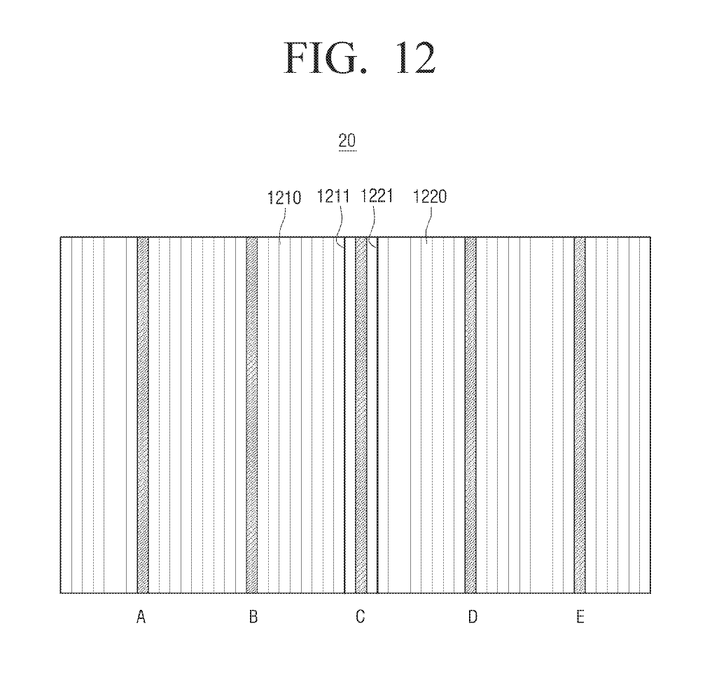

FIG. 12 is a third demonstration diagram provided to describe an exemplary embodiment of editing a content bar included in a content guide UI in a display apparatus according to still another exemplary embodiment.

As illustrated in FIG. 12, the controller 130 may edit the content bars included in the content guide UI 20 according to selection history information included in the predetermined condition. To be specific, the content bars corresponding to Categories A to D may be arranged sequentially on the content guide UI 20. Meanwhile, the storage 150 may store the selection history information on the content bar selected by the user from among the content bars corresponding to Categories A to D. The selection history information may be updated in response to at least one of the content bars corresponding to Categories A to D being selected.

Accordingly, the controller 130 may set a thickness of at least one stripe-patterned line among a plurality of stripe-patterned lines included in a space area adjacent to a content bar having higher selection frequency from among the content bars corresponding to Categories A to D differently from a thickness of other stripe-patterned lines based on the stored selection history information.

As illustrated, the content bar corresponding to Category C may be selected by the user frequently from among the content bars corresponding to Categories A to D. In this case, the controller 130 may set the thickness of first stripe-patterned lines 1211, 1211 in the space areas 1210, 1220 adjacent to the content bar corresponding to Category C among the plurality of stripe-patterned lines included in the space areas 1210, 1220 adjacent to the content bar corresponding to Category C to be thicker than the thickness of other stripe-patterned lines in the space areas 1210, 1220.

Accordingly, the display 120 may display the thickness of the first stripe-patterned lines 1211, 1221 in the space areas 1210, 1220 adjacent to the content bar corresponding to Category C differently from the thickness of other stripe-patterned lines.

As above, the components of the display apparatus according to the exemplary embodiments have been described in detail. Hereinafter, there is provided the detailed description on a method for controlling a display apparatus according to an exemplary embodiment.

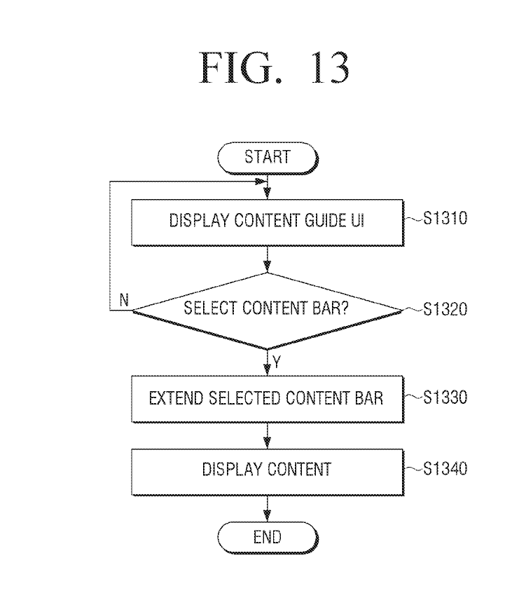

FIG. 13 is a flowchart provided to describe a method for displaying content in a display apparatus according to an exemplary embodiment.

As illustrated in FIG. 13, the display apparatus displays a content guide UI (or GUI) including a plurality of content bars classified by category (S1310). To be specific, the display apparatus executes an application for intuitionally providing content and displays a start UI of the application in response to a user command. According to an exemplary embodiment, the start UI may include a plurality of stripe-patterned lines.

In this state, the display apparatus determines whether a predetermined event occurs. In response to the predetermined event occurring, the display apparatus generates a content guide UI and displays the generated content guide UI in a screen. In this case, the predetermined event may be an event where a user motion is sensed or an event where a user touch command is received. The content guide UI may include a plurality of content bars which are apart from each other at a predetermined distance in a vertical pattern and classified by category and a space area including a plurality of stripe-patterned lines between the plurality of content bars.

The content guide UI may further include identification information for identifying a category corresponding to each of a first content bar and a second content bar on the first content bar and the second content bar included in the content guide UI.

The display apparatus which displays the content guide UI may set and display at least one of a thickness, a color, an arrangement order, and a bookmark of the first content bar and the second content bar according to a predetermined condition. In this case, the predetermined condition may include at least one of user setting information, selection history information, and content attribute information.

According to an exemplary embodiment, in response to the content guide UI being displayed based on the selection history information in the predetermined condition, the display apparatus may display a thickness of at least one stripe-patterned line adjacent to a content bar having higher selection frequency out of the first content bar and the second content bar included in the content guide UI differently from a thickness of other stripe-patterned lines based on the selection history information.

According to another exemplary embodiment, in response to the content guide UI being displayed based on the user setting information in the predetermined condition, the display apparatus may display the content guide UI where a bookmark is displayed on a content bar that the user uses frequently based on the user setting information.

According to still another exemplary embodiment, in response to the content guide UI being displayed based on the user setting information in the predetermined condition, the display apparatus may rearrange the content bars in the order of a content bar classified into a category including a content that the user uses frequently and display the content guide UI where the content bars are rearranged, based on the user setting information.

In response to the content guide UI including the plurality of content bars being displayed, the display apparatus determines whether at least one content bar is selected from among the plurality of content bars included in the content guide UI (S1320).

In response to one content bar being selected from among the plurality of content bars, the display apparatus extends the selected content bar (S1330). According to an exemplary embodiment, the display apparatus may extend the plurality of content bars differently based on the extension information on the category corresponding to each of the plurality of content bars. Accordingly, in response to a content bar being selected from among the plurality of content bars, the display apparatus may extend the selected content bar based on the extension information on the category corresponding to the selected content bar. In response to the selected content bar being extended and a content area being generated, the display apparatus displays at least one content included in the category corresponding to the selected content bar in the generated content area in a screen (S1340).

In response to a plurality of contents being included in the category corresponding to the selected content bar, the display apparatus generates thumbnail contents with respect to the plurality of contents and displays the thumbnail contents with respect to the plurality of contents in the content area generated by the extended content bar. In response to a thumbnail content being selected while the thumbnail contents with respect to the plurality of contents are displayed in the content area, the display apparatus displays in the screen a detailed content on the selected thumbnail content.

The display apparatus may adjust extension of the content area for displaying the detailed content and display the detailed content in the adjusted content area. For example, in response to the selected thumbnail content being a content related to a moving image, the display apparatus may further extend the extended content area and display a detailed content on the selected thumbnail content. In response to the selected thumbnail content being a content related to a document in a text form, the display apparatus may display a detailed content on the selected thumbnail content in the corresponding content area without further extending the content area.

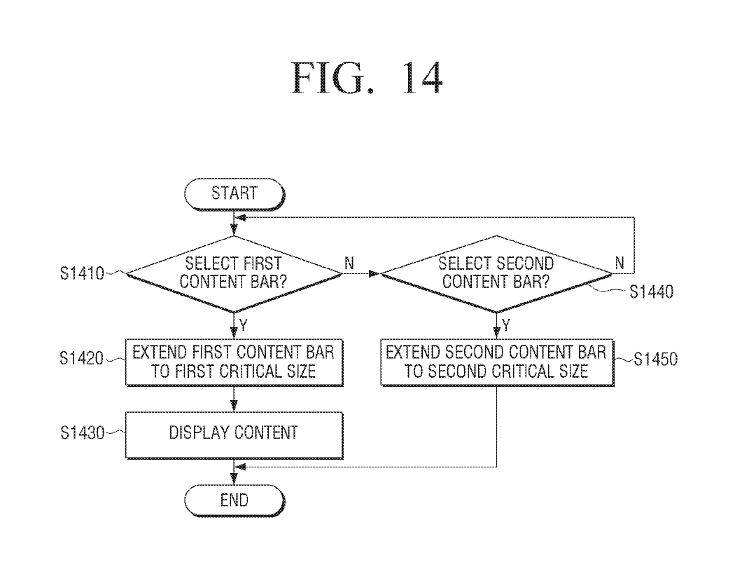

FIG. 14 is a flowchart provided to describe a method for extending a content bar in a display apparatus according to an exemplary embodiment.

As illustrated in FIG. 11, in response to a content bar being selected from among the plurality of content bars included in the content guide UI, the display apparatus determines whether the selected content bar is a first content bar (S1410). In response to determining that the selected content bar is the first content bar, the display apparatus extends the first content bar to a first critical size based on extension information on a category corresponding to the first content bar (S1420).

In response to the first content bar being extended or expanded to the first critical size, the display apparatus adjusts at least one of adjacent content bars and a space area based on the extended first critical size. According to an exemplary embodiment, in response to the first content bar being extended to the first critical size, the display apparatus may move a second content bar adjacent to the first content bar and a space area between the first content bar and the second content bar by an amount of the first critical size.

According to another exemplary embodiment, in response to the first content bar being extended to the first critical size, the display apparatus may adjust a space area adjacent to the first content bar by the amount of the first critical size.

In response to the first content bar being extended to the first critical size and a content area being generated, the display apparatus displays at least one content included in the category corresponding to the first content bar in the generated content area in the screen (S1430).

In response to determining that the content bar selected at S1410 not being the first content bar, the display apparatus determines whether the content bar selected by the user is the second content bar (S1440). In response to determining that the content bar selected by the user is the second content bar, the display apparatus extends the second content bar to a second critical size based on extension information on a category corresponding to the second content bar (S1450).

In response to the second content bar being extended to the second critical size, the display apparatus adjusts at least one of the adjacent content bars and a space area based on the extended second critical size. According to an exemplary embodiment, in response to the second content bar being extended to the second critical size, the display apparatus may move a third content bar adjacent to the second content bar and a space area between the second content bar and the third content bar by an amount of the second critical size.

According to another exemplary embodiment, in response to the second content bar being extended to the second critical size, the display apparatus may adjust a space area adjacent to the second content bar by the amount of the second critical size.

In response to the second content bar being extended to the second critical size and a content area being generated, the display apparatus displays at least one content included in the category corresponding to the second content bar in the content area generated at S1430.

As above, a few exemplary embodiments have been shown and described.

The foregoing exemplary embodiments and advantages are merely exemplary and are not to be construed as limiting the present concept. The present teaching can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A method for controlling a display apparatus, the method comprising:
displaying a content guide User Interface (UI) including a plurality of content bars classified by category;
extending, in response to a content bar being selected from among the plurality of content bars, a selected content bar as an extended content bar; and
displaying at least one content included in a category corresponding to the selected content bar in a content area generated by the extended content bar.

2. The method as claimed in claim 1, wherein the content guide UI comprises:
a first content bar and a second content bar which are apart from each other at a predetermined distance in one of a vertical and horizontal pattern; and
a space including a plurality of stripe-patterned lines between the first content bar and the second content bar.

3. The method as claimed in claim 2, wherein the displaying the content guide UI comprises displaying identification information for identifying a category corresponding to each of the first content bar and the second content bar on the first content bar and the second content bar, respectively.

4. The method as claimed in claim 2, wherein the displaying the content guide UI comprises setting and displaying at least one of a thickness, a color, an arrangement order, and a bookmark of the first content bar and the second content bar according to a predetermined condition,
wherein the predetermined condition comprises at least one of user setting information, selection history information, and content attribute information.

5. The method as claimed in claim 4, wherein the displaying the content guide UI comprises displaying a thickness of at least one stripe-patterned line adjacent to the content bar having higher selection frequency from among the first content bar and the second content bar differently from the thickness of other striped-patterned lines based on the selection history information.

6. The method as claimed in claim 2, wherein in response to the first content bar being selected, the extending the selected content bar comprises extending a selected first content bar to a first critical size based on first extension information for the category corresponding to the first content bar, and in response to the second content bar being selected, extending a selected second content bar to a second critical size based on second extension information for the category corresponding to the second content bar,
wherein the first content bar and the second content bar are extended in one of a horizontal direction and a vertical direction.

7. The method as claimed in claim 6, wherein in response to the first content bar being extended to the first critical size, the extending the selected content bar comprises moving the second content bar and the space between the first content bar and the second content bar by an amount of the first critical size.

8. The method as claimed in claim 6, wherein in response to the first content bar being extended to the first critical size, the extending the selected content bar comprises adjusting the space adjacent to the first content bar by an amount of the first critical size.

9. The method as claimed in claim 1, wherein the displaying the at least one content comprises:
displaying a plurality of thumbnail contents in the content area generated by the extended content bar; and
displaying, in response to a thumbnail content being selected from among the plurality of thumbnail contents, a detailed content of a selected thumbnail content.

10. The method as claimed in claim 9, wherein the displaying the detailed content comprises adjusting an extension of the content area for displaying the detailed content and displaying the detailed content in an adjusted content area according to an attribute of the selected thumbnail content.

11. A display apparatus, comprising:
a display configured to display a content guide User Interface (UI) including a plurality of content bars classified by categories; and
a controller configured to, in response to a content bar being selected from among the plurality of content bars as a selected content bar, extend the selected content bar as an extended content bar and control the display to display at least one content included in a category corresponding to the selected content bar in a content area generated by the extended content bar.

12. The apparatus as claimed in claim 11, wherein the content guide UI comprises:
a first content bar and a second content bar which are apart from each other at a predetermined distance in one of a vertical and horizontal pattern; and
a space including a plurality of stripe-patterned lines between the first content bar and the second content bar.

13. The apparatus as claimed in claim 12, wherein the controller controls the display to display identification information for identifying the category corresponding to each of the first content bar and the second content bar on the first content bar and the second content bar, respectively.

14. The apparatus as claimed in claim 12, wherein the controller sets at least one of a thickness, a color, an arrangement order, and a bookmark of the first content bar and the second content bar according to a predetermined condition,
wherein the predetermined condition comprises at least one of user setting information, selection history information, and content attribute information.

15. The apparatus as claimed in claim 14, wherein the controller sets a thickness of at least one stripe-patterned line adjacent to the content bar having higher selection frequency among the first content bar and the second content bar differently from the thickness of other striped-patterned lines based on the selection history information.

16. The apparatus as claimed in claim 12, wherein in response to the first content bar being selected, the controller extends the selected first content bar to a first critical size based on first extension information for the category corresponding to the first content bar, and in response to the second content bar being selected, extends selected second content bar to a second critical size based on second extension information for the category corresponding to the second content bar,
wherein the first content bar and the second content bar are extended in one of a horizontal direction and a vertical direction.

17. The apparatus as claimed in claim 16, wherein in response to the first content bar being extended to the first critical size, the controller moves the second content bar and the space between the first content bar and the second content bar by an amount of the first critical size.

18. The apparatus as claimed in claim 16, wherein in response to the first content bar being extended to the first critical size, the controller adjusts the space adjacent to the first content bar by an amount of the first critical size.

19. The apparatus as claimed in claim 11, wherein the controller controls the display to display a plurality of thumbnail contents in the content area generated by the extended content bar and in response to a thumbnail content being selected from among the plurality of thumbnail contents, display a detailed content of a selected thumbnail content.

20. The apparatus as claimed in claim 19, wherein the controller controls the display to adjust an extension of the content area for displaying the detailed content and display the detailed content in an adjusted content area according to an attribute of the selected thumbnail content.
